(19) United States
(12) Patent Application Publication
(10) Pub. No.: US 2005/0287052 A1
(43) Pub. Date: Dec. 29, 2005

(54) Smoke odour abatement devices and methods

(76) Inventors: Christopher Warren Ravanello, Vancouver (CA); David Miller Torrance, Lions Bay (CA)

Correspondence Address: FULBRIGHT & JAWORSKI L.L.P., 600 CONGRESS AVE., SUITE 2400, AUSTIN, TX, 78701, US

(21) Appl. No.: 10/876,370

(22) Filed: Jun. 24, 2004

(51) Int. Cl. B03C 3/00

(52) U.S. Cl. 422/186.07

(57) ABSTRACT

Devices and methods for the abatement of smoke odour contamination using pressurized ozone containing treatment gas is described. One of the devices comprises an assembly of components which generate an ozone containing treatment gas, pressurize the treatment gas and inject the treatment gas into a smoke-affected cavity through a penetration opening, preferably an opening through which smoke was forced into the cavity during the preceding fire. Used treatment gas can optionally be collected from the cavity, filtered and admixed with fresh ozone treatment gas. The devices and methods substantially obviate the cost and time intensive remediation method of stripping open smoke affected cavities for treatment.

### FIELD OF THE INVENTION

The present invention relates generally to smoke odour abatement. More particularly, the present invention relates to devices and methods for the remediation of smoke odour contamination in buildings.

### BACKGROUND OF THE INVENTION

The problem of smoke odour contamination of buildings that have been damaged by fire, or by exposure to smoke from fires in the vicinity, is a very common occurrence. During most interior building fires, there is a rapid build up of gas pressure due to the heat created by the fire. This pressure forces smoke into cavities within the building structure, such as wall cavities, drop ceilings, and the like through electrical and plumbing openings, around door frames, windows, etc. This internal contamination of the building structure must be removed to combat residual smoke odour. Due to the permeation of smoke residue into these various enclosed spaces, the traditional restoration industry solution of remediation is to strip out wall, ceiling and floor finishes to open all such enclosed spaces for physical access to the enclosed smoke affected surfaces and materials and application of various odour neutralization substances and treatments. These methods are very time consuming and expensive, both in terms of the strip out process, and in terms of the time and cost of reinstating all of the finishes removed in the process, including associated fixtures, fittings, services, etc. Additionally, there are other secondary costs relating to business interruption expense, loss of rents and living out expenses. For older buildings, subject to significant strip out, major costs may have to be incurred to bring the building structure into compliance with current building code and bylaw requirements.

Ozone is known in the art as an effective chemical for smoke odour abatement. Ozone-generating abatement devices are useful for treating large rooms and areas affected by smoke damage. In most systems, smoky, ambient air passively diffuses into a collection vessel where it is treated with an ozone composition and one or more filters, before being returned either to the room or to the environment.

U.S. Pat. No. 5,904,896 discloses a multi-stage air filtration and purification system for indoor environments, such as rooms or zones of rooms which may be contaminated with particulates, organic compounds or smoke. The system intakes air from the room and drives it via a motor driven fan through a series of treatment units, including an electrostatic particle filter unit, a high density microfiber filter unit and, in one embodiment, an ozone generator, before being blown back into the room.

U.S. Pat. No. 3,949,055 discloses a process for destroying oxidizable gaseous or smoke-like substances using an acidified aqueous solution of ozone. Foul air is sent into the system and purified in the aqueous ozone solution before being released.

U.S. Pat. No. 5,968,214 discloses an air cleaning apparatus used in the air conditioning duct of a vehicle. The device uses ozone and activated charcoal to remove cigarette smoke odour from the air inside the vehicle. Ambient air diffuses into the air chamber and mixes with the ozone before being filtered by the charcoal and returned to the vehicle.

U.S. Pat. No. 5,983,834 discloses a method and system for injecting ozone into a building used for keeping livestock. The ozone is transferred from ozone generators into the ambient air, thus reducing dust, flies, humidity and disease susceptibility.

Japanese application JP 04286685 discloses a large space air processing system including one or more ozone generating devices, fans and smoke sensors.

Japanese application JP 06259711 discloses an air conditioning and deodorizing apparatus. The apparatus filters the air in an indoor space to remove dust and then passes it through an ozone generating unit.

Typical ozone-generating smoke abatement devices are prohibitively large for use in most smaller buildings. It is difficult, thus, to treat remote areas of buildings which may not permit access with such devices. Further, despite their prevalence in the art, the prior art devices are restricted to the filtering and cleaning of ambient air and do not address the issue of smoke contamination of hard to reach smoke affected spaces and cavities enclosed within a building structure. However, it is the smoke contamination of and damage to the materials in these enclosed spaces which if untreated will cause a persistent residual smoke odour problem in the building. Thus, the current very costly practice is to strip open all such enclosed spaces for treatment. Treating the ambient air in the building is ineffective in treating these hard-to-reach building cavities and crevices which can receive much smoke infiltration during the fire due to the increased pressure generated in the building. Thus, current ambient air processing and ozone based smoke odour abatement devices are not suitable for the treatment of enclosed, smoke affected spaces. In most situations, concealed smoke odour problems result from carbon based particles. These particles can be neutralized with the prior art ozone based methods only when borne by the ambient air in a building, but not when trapped within building cavities.

### SUMMARY OF THE INVENTION

The inventors of the present methods and apparatuses have now surprisingly found that ozone containing treatment gas can be used even for smoke odour abatement in enclosed building cavities. This is achieved by substantially replicating the pressurization conditions which initially resulted in the smoke penetrating into those cavities through penetration openings. Pressurized treatment gas is thereby forced into the cavities through the penetration openings and along a path originally taken by the smoke. By forcing the treatment composition into the building cavities not only contaminated gases in the cavities are removed, but the treatment composition is forced into porous materials in and around the cavity and thereby neutralizes the smoke odour causing carbon based particles in the cavity. As a result, the need for the opening up of enclosed building cavities as in the conventional smoke damage remediation methods is substantially obviated.

In one aspect, the present invention provides a smoke odour abatement device for the treatment of an enclosed smoke affected cavity within a building structure accessible through a penetration opening, including an ozone generator configured to produce an ozone containing treatment gas composition; a pressurizing unit configured to pressurize the treatment gas produced by the ozone generator, a supply conduit connected to the pressurizing unit and configured to supply the pressurized treatment gas to the building cavity, and an adapter configured to substantially sealingly connecti the supply conduit to the penetration opening of the building cavity to permit a supply of pressurized treatment gas into the building cavity.

In this context, the term penetration opening means all points of access or openings in the building structure which would permit infiltration of pressurized smoke gases into a building cavity during a fire, or any additional openings created after the fire to permit fluid access to the cavity, including, but not limited to electrical, heating and plumbing openings, gaps and cracks along doors, windows and base boards and gaps and cracks in wall, ceiling and floor finishes, or openings cut into wall, ceiling and floor finishes to permit fluid communication with an underlying building cavity.

The term smoke affected cavity in this context refers to any enclosed space within a building structure accessible to pressurized smoke gases during a fire and includes, but is not limited to, walls, drop ceilings, floors, ducting, small storage areas or rooms and the like.

In another aspect, the invention provides a smoke odour abatement method for treating an enclosed smoke affected cavity within a building structure, comprising generating an ozone containing treatment gas, pressurizing the treatment gas and injecting the treatment gas into the cavity to pressurize the cavity with the treatment gas. The step of injecting the treatment gas preferably includes the steps of identifying a first penetration opening into the cavity and forcing the treatment gas through the first penetration opening into the cavity.

A preferred embodiment of the smoke odour abatement method includes the further steps of identifying a second penetration opening into the cavity and which is spaced remote from the first penetration opening, collecting used treatment gas exiting the second penetration opening and reusing the used treatment gas for pressurizing and injecting into the cavity. The method preferably includes the additional step of filtering the used treatment gas prior to reusing. For increased pressure and flow of the treatment gas in the cavity, the method prior to injecting of the treatment gas may include the further step of identifying and sealing penetration openings into the cavity other than the first and second penetration opening.

In a further aspect, the present invention provides a portable smoke odour abatement device for removing odour from a smoke-affected cavity accessible through a penetration opening, comprising an induction unit configured to receive ambient supply air, an oxygen concentrator that is connected to the induction unit and configured to concentrate the amount of oxygen in the supply air, an ozone generator that is connected to the oxygen concentrator and configured to generate ozone from the concentrated oxygen in the supply air to form an ozone containing treatment gas, a high velocity delivery unit that is connected to the ozone generator and configured to pressurize the treatment gas, a manifold splitter component that is connected to the delivery unit and configured to receive and disperse the treatment gas, adjustable dampers that are attached to the manifold splitter component and configured to control an outflow of the treatment gas from the manifold component, a supply air duct that is attached to the adjustable dampers and configured to supply the treatment gas to the cavity, and a wall plate adaptor configured to link the supply air duct to the penetration opening for fluid communication with the smoke-affected cavity.

Optionally, the smoke odour abatement device of the present invention further comprises an outlet port in fluid connection with the cavity through a penetration opening distal to the wall plate adaptor to receive used treatment gas exiting from the smoke-affected cavity, and a gas return unit that is connected to the outlet port and configured to return the used treatment gas to the pressurizing unit. The gas return unit preferably includes a filter unit configured to filter particulates from the used treatment gas prior to the return thereof into the pressurizing unit. The filter unit preferably includes a filter selected from the group consisting of a carbon filter, an electrostatic filter, a HEPA filter and a combination thereof.

The portable device in accordance with the invention preferably further includes a duct connecting the outlet port to a filter unit attached to the exterior of the high velocity delivery unit, and a filter configured to filter the used treatment gas return flow. The filtered used treatment gas is preferably mixed with the treatment gas in the high velocity delivery unit.

In still another aspect, the present invention provides a method of smoke abatement of a smoke-affected cavity accessible through a penetration opening, comprising concentrating oxygen in ambient air to produce oxygen enriched air, generating ozone to be mixed with the oxygen enriched air to form an oxygen enriched, ozone containing treatment gas, and injecting the treatment gas into the smoke-affected cavity through the penetration opening. The method supplies pressurized treatment gas to the affected area in a controlled manner to effectively remove odour caused by smoke infiltration and contamination. For large cavities in a building structure, the method further includes the step of subdividing the smoke affected cavity into a number of smaller cavities of a size more easily and efficiently treated by the present method.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only and with reference to the attached Figures, wherein:

FIG. 1 is a schematic block diagram of one embodiment of the smoke odour abatement process in accordance with the invention;

FIG. 2 is a schematic diagram of one embodiment of the smoke abatement device of the present invention;

FIG. 3 is a schematic block diagram of another embodiment of the smoke odour abatement process in accordance with the invention; and

FIG. 4 is a schematic diagram of an embodiment of a portable smoke odour abatement device in accordance with the invention.

### DETAILED DESCRIPTION

Generally, the present invention provides devices and methods for smoke odour abatement in smoke damaged buildings. In one aspect, the present invention provides a smoke odour abatement device for neutralizing odour in a smoke-affected cavity within a building structure. The device produces a pressurized ozone containing treatment gas and forces the treatment gas into the cavity through a penetration opening in the building structure, thereby substantially replicating pressurization conditions present during the fire. The device preferably includes an ozone generator for producing an ozone containing treatment gas, a pressurizing unit for pressurizing the treatment gas, a supply conduit for delivering the pressurized treatment gas to the cavity and an adaptor for linking the supply conduit to the smoke affected cavity through the penetration opening. Optionally, the device provides an outlet port adaptor for receiving used treatment gas from the smoke affected cavity and a return unit for returning the used treatment gas to the pressurizing unit.

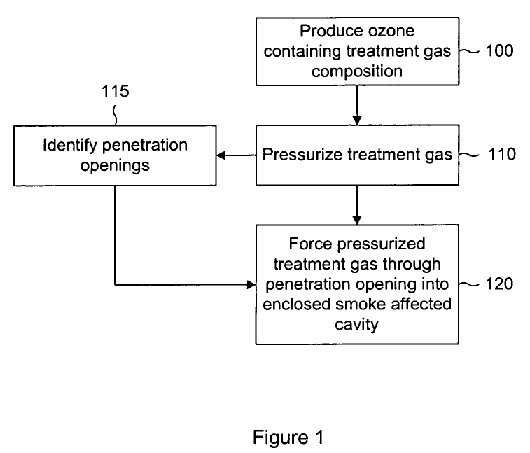

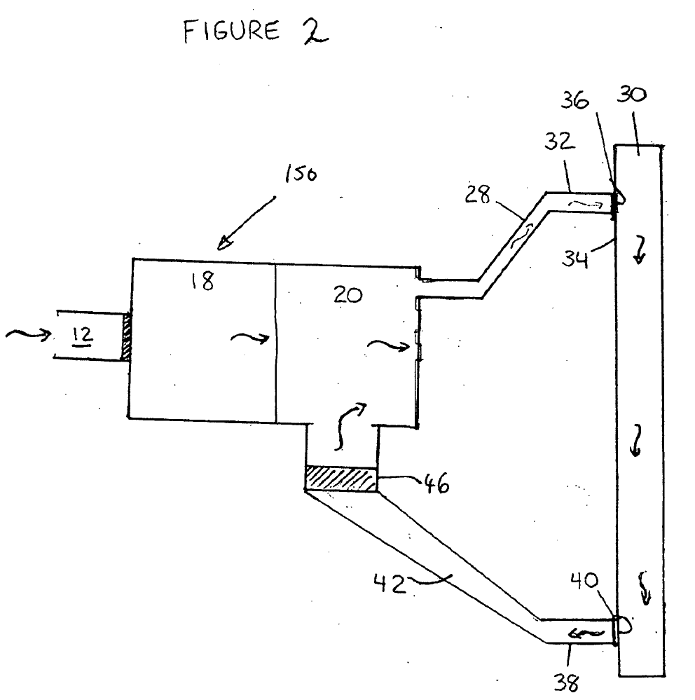

FIG. 1 illustrates one embodiment of the smoke odour abatement process in accordance with the invention for the treatment of a smoke affected cavity (not shown). The process includes an ozone generation step 100 wherein an ozone generator (see FIG. 2) is used to produce an ozone enriched treatment gas composition, a pressurization step 110, wherein a pressurizing unit (see FIG. 2) is used to pressurize the treatment gas, and an injection step 120 wherein the pressurized treatment gas is forced through a penetration opening (not shown) into the cavity. The penetration opening may be any point of access or opening in a building structure which would permit infiltration of pressurized smoke gases into a building cavity during a fire or any additional openings created after the fire to permit fluid access to the cavity, including, but not limited to electrical, heating and plumbing openings, gaps and cracks along doors, windows and base boards and gaps and cracks in wall, ceiling and floor finishes, or openings cut into wall, ceiling and floor finishes which opening permits fluid communication with an underlying smoke affected building cavity. The process may further include the intermediate step 115 of identifying a penetration opening for fluid communication with the cavity. The identifying step 115 preferably includes the identification of a penetration opening through which smoke entered the cavity during the preceding fire.

FIG. 2 shows a schematic diagram of one embodiment of a smoke odour abatement device in accordance with the invention. The device 150 includes in the most general configuration an ozone generator 18 having an intake conduit 12 for aspirating and filtering ambient air, the generator producing an ozone enriched treatment gas composition. Ozone generators suitable for use in a device in accordance with the invention are those which can produce ozone from an oxygen containing gas, preferably air, more preferably oxygen enriched air. Bottled oxygen may be used for the enrichment of ambient air with oxygen prior to supply to the ozone generator. Ozone generators of the coronal discharge type are most common and can be used in the present invention. A suitable ozone generator would be the Azcozon™ CDO-8000 model commercially available from Azco Industries Ltd. A pressurization unit 20 is connected to the ozone generator 18 which receives and pressurizes the treatment gas produced in the generator. A suitable pressurization unit is the model MB4860L commercially available from Unico Systems Ltd. In general, any pressurization unit may be used, but units capable of delivering a sufficient flow of pressurized treatment gas to substantially replicate the pressurization conditions in the cavity during the fire are preferred. A pressurized treatment gas supply duct 28 is connected to the pressurization unit 20 and configured to supply the pressurized treatment gas to a smoke affected cavity such as a wall cavity 30 in a building structure 34.

In this disclosure, a structure, such as a pressurized treatment gas supply duct, that is configured to perform a function, such as supplying pressurized treatment gas to a smoke affected cavity, is configured to perform at least that function, and may be capable of performing other functions not listed. An equivalent characterization of such a structure is a pressurized treatment gas supply duct that supplies the pressurized treatment gas to a smoke affected cavity. Similar equivalent characterizations exist for each structure in this disclosure that is configured to perform a function. Thus, an ozone generator configured to produce an ozone containing treatment gas may be characterized as an ozone generator that produces an ozone containing treatment gas. This style of interpretation applies equally to strucutres that are “constructed for” performing certain functions.

The connection of the supply duct with the cavity 30, especially for fluid communication therebetween, is achieved with an adaptor, preferably a wall plate adaptor 36. The adaptor 36 is constructed for mounting to the building structure 34 for reliable connection of the supply duct 28 to the building structure at a penetration opening 36 to provide fluid communication between the supply duct 28 and the cavity 30 through the penetration opening 36. The adapter 36 is preferably constructed for attachment to an electrical, plumbing or heating access opening into the cavity 30. The device preferably further includes a used treatment gas return duct 42 configured to collect the used treatment gas from the cavity 30 for recycling to the pressurization unit 20. The return duct 42 is preferably mounted to a second penetration opening 40 in the building structure 34 distal from the first penetration opening by way of an outlet port adaptor 38 constructed for reliably mounting the adaptor to the building structure 34 and the return duct to permit fluid communication between the cavity 30 and the return duct 42 through the penetration opening 40. The return duct 42 preferably includes a filter unit 46 configured to remove suspended particulates from the used treatment gas prior to recycling thereof into the pressurization unit 20.

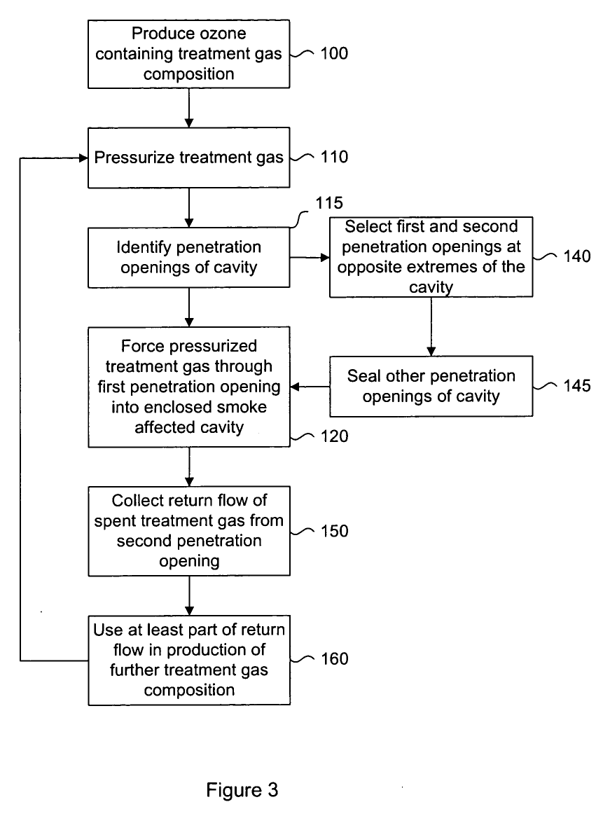

FIG. 3 illustrates another embodiment of a smoke odour abatement process in accordance with the invention for the treatment of a smoke affected cavity accessible through a penetration opening (see FIG. 2). The process of this embodiment includes the basic steps of the process shown in FIG. 1 and equivalent steps are defined by the same reference numerals. Thus, the process includes the ozone generation step 100, the pressurization step 110, the penetration openings identification step 115 and the injection step 120 of the process of FIG. 1. However, in the process of this embodiment, the ozone generation step 100 further includes the step of concentrating oxygen in the filtered ambient air to produce oxygen enriched air. The process also includes additional steps. In a collection step 150, used treatment gas is removed from the cavity 30 (see FIG. 2) through a second penetration opening remote from the penetration opening through which the treatment gas is injected. Furthermore, in a subsequent recycling step 160, at least a part of the used treatment gas is returned to the pressurization step 110 for use in the preparation of further treatment gas. The method may also include an optional selection step 140 in which out of all the penetration openings identified in the identification step 115 a pair of first and second penetration openings is selected which are preferably located at opposite extremes of the cavity 30 (see FIG. 2). In an optional sealing step 145, penetration openings other than the first and second penetration openings are sealed to more positively control the direction and size of the flow of treatment gas through the cavity. The method supplies pressurized treatment gas to the affected area in a controlled manner to effectively remove odour caused by smoke infiltration and contamination. For large cavities in a building structure, the method further includes the further step (not shown) of subdividing the smoke affected cavity into a number of smaller cavities of a size more easily and efficiently treated by the present method.

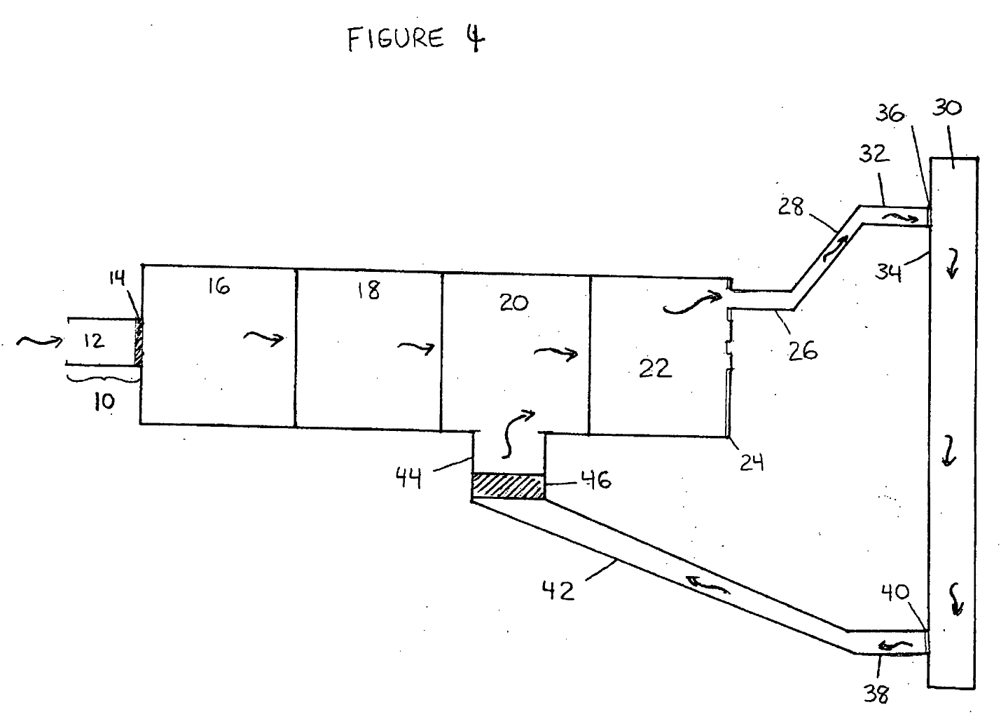

FIG. 4 illustrates one embodiment of a portable smoke abatement device in accordance with the present invention. This portable device has been given the name Abatement Pro 9000 ™ Smoke Abatement Device (referred to hereafter as “AP9000”) and is commercially available from Barclay Restorations Ltd., Vancouver, Canada. Wavy arrows indicate the direction of gas flow in the AP9000. The AP9000 represents a unique integrated system to address and resolve smoke odour contamination of enclosed cavities. Typically, the AP9000 is used to decontaminate cavities which are not readily treated with currently-available smoke odour abatement systems. These cavities can include, but are not limited to, crevices behind walls, ceilings, floors, ducts, and small rooms. Advantageously, the AP9000 is flexible to be used in a wide variety of smoke-affected areas and can be adjusted depending on the size and dimensions of the area and the efficacy of other available treatment methods such as pressure washing, blasting (with such as dry ice, soda or sand), or manual cleaning.

An induction unit 10 provides the main air supply for the AP9000. The induction unit comprises an intake 12 which can be ducted to the outdoors or into another room. The intake has a diameter of about 4″, although this can be adjusted as required. An intake filtration unit 14 is incorporated into the intake to remove contaminants from the incoming supply air. Filtration contributes to the enhanced treatment capabilities of the oxygen enriched ozone treatment mixture.

Supply air is drawn through a dessicant filter and through the intake into an oxygen generator 16. The oxygen generator boosts the supply air to an oxygen concentration of above about 80%, preferably above 90%, most preferably 95%. This results in an enhanced pure and concentrated oxygen composition which will be used for producing a more effective ozone treatment composition (see below). An oxygen concentrator suitable for use in this embodiment is commercially available under the name Azcozon VM B08 from Azco Industries Ltd.

Highly-oxygenated supply air enters an ozone generator 18, where the supply air is super-charged with additional oxygen molecules in the form of ozone. Concentrated supply air which enters the ozone generator is treated to produce an ozone treatment composition that is significantly higher in ozone (in terms of parts per million) than unfiltered or un-concentrated supply air. Advantageously, this enhanced ozone treatment composition has significantly improved smoke odour neutralizing properties. A suitable ozone generator as identified above, when supplied with enriched air having an oxygen content of about 80% to 95%, produces an ozone containing treatment gas composition having an ozone content of about 7 to 9 ppm. The ozone content in the treatment gas is preferably maintained at a level of about 7 ppm. Ozone is hazardous at these levels and the treatment area must be contained and controlled during, and immediately after, treatment. The ozone containing treatment gas composition is pressurized to a high static pressure in a high velocity delivery unit 20. The high velocity delivery unit and the pressurization unit (Barclay Restorations Ltd., Vancouver, Canada) function together to provide a flow (i.e., supply volume, pressure and chemical composition) of treatment gas effective for neutralizing smoke odour-affected spaces and cavities. If the treatment process in use in a specific context is planned to incorporate recirculation of the treatment mixture, then the high velocity delivery unit 20 also functions as the inlet port for the treatment mixture which has already been pressurized through the subject enclosed cavity, and then through the appropriate carbon, electrostatic and/or hepa filtration units.

The ozone treatment composition leaves the high velocity delivery unit and is passed into a manifold splitter component 22. Pressurized ozone treatment composition is dispersed through a splitter unit 24 to the affected odour location. Suitable splitter manifolds are commercially available from Barclay Restorations Ltd., Vancouver, Canada. Using one or more adjustable dampers 26, the manifold splitter component delivers, monitors and controls the concentration, volume and pressure of ozone flow into a smoke-infiltrated area, thus ensuring that smoke odour abatement in the affected area is effective.

A supply duct 28 is attached to the adjustable damper of the manifold splitter component to direct the ozone treatment composition to a smoke-affected area 30. One or more supply ducts can be used depending on the size of the affected area and the amount of smoke infiltration. FIG. 4 illustrates an embodiment of the present invention where only one damper and one supply duct is used. However, it should be apparent to one skilled in the art that additional dampers and supply ducts can be attached to the manifold splitter component as the need arises, such as in the case of a large smoke-affected area where a single supply duct would not suffice. The supply duct is preferably flexible to facilitate handling and installation of the device and many different types of suitable air ducts will be known to the art skilled person. Of course, the supply duct should be resistant to attack by ozone. It is preferred to keep the supply duct as short as possible to minimize pressure losses. The supply air duct is connected to a wall plate supply adaptor 32 which serves as a conduit on the surface 34 of the affected areas (such as a wall cavity) for the passing of the ozone containing treatment gas. The wall plate supply adaptor is specially designed so that easy installation can be made over existing apertures (e.g., plug, switch or light fixture outlets) with little damage to surrounding surfaces. Suitable wall plate adaptors are available from Barclay Restorations, Vancouver, Canada. The wall plate supply adaptor also allows for the control of flow rates and pressure of the treatment gas which can be adjusted for the requirements of each specific situation. The wall plate supply adaptor is used for maintaining a pressure which replicates the pressure exerted during the initial smoke odour contamination process. In most instances of smoke odour contamination in concealed cavities, elevated levels of ambient gas pressures are created during the fire, either resulting from the combustion which creates the smoke, but occasionally from natural climatic causes or from mechanical venting equipment. It is this elevated pressure which forces the smoke odour into the cavity originally through existing openings and it is the use of the present devices and methods, preferably plus the wall plate adaptors, which allows for the recreation of this pressure using the concentrated, pressurized treatment mixture.

After the odour neutralization process, treatment gas return flow leaves the smoke-affected area via one or more wall plate return adaptors 38 attached to one or more outlet ports 40. The wall plate return adaptor is typically the same as the wall plate supply adaptor as described above, to provide control for the removal of the ozone treatment composition return flow out of the smoke-affected area. In one embodiment, the return flow is directed from the affected area through a wall plate return adaptor attached to an outlet port located distally to the wall plate supply adaptor. The return flow exits from the wall plate return adaptor into a return air duct 42 and to a filter unit 44 connected to the high velocity delivery unit of the AP9000. A return air filter 46 (carbon, electrostatic, HEPA, or a combination of two or more filters) in the filter unit is used to filter the return flow, thus removing all residual contaminants. Filtered return flow is then reintroduced into the high velocity delivery unit for recirculation.

The present invention also provides a method of smoke odour abatement comprising introducing air to an induction unit, concentrating the oxygen in the air, generating ozone from the concentrated air to form an ozone treatment composition, and propelling the ozone treatment composition into a smoke-affected area.

Thus, the present devices and methods represent an advancement in the art of smoke-odour abatement devices and methods. Unlike other commercially-available smoke abatement procedures which typically utilize a “passive” system of treating ambient air with ozone, the present devices and methods actively mimic the initial smoke infiltration process by providing a focussed, controlled and pressurized ozone containing treatment gas composition to decontaminate a smoke-affected area.

The above-described embodiments are intended to be examples only. Alterations, modifications and variations may be effected to the particular embodiments by those of skill in the art without departing from the scope of the invention, which is defined solely by the appended claims.

1. A smoke odour abatement device for the treatment of an enclosed smoke affected cavity within a building structure accessible through a first penetration opening, comprising
an ozone generator configured to produce an ozone containing treatment gas;
a pressurizing unit connected to the ozone generator and configured to pressurize the treatment gas produced by the ozone generator; and
a supply unit connected to the pressurizing unit and configured to inject the pressurized treatment gas into the building cavity.

2. The device of claim 1, wherein the supply unit further includes a supply conduit connected to the pressurizing unit and configured to supply the pressurized treatment gas to the building cavity, and an adaptor configured to connect the supply conduit to the first penetration opening of the building cavity to permit injection of pressurized treatment gas into the building cavity through the first penetration opening.

3. The device of claim 2, further comprising a used treatment gas return conduit configured to recycle used treatment gas from the building cavity to the pressurizing unit, and an outlet adapter configured to connect the return conduit to a second penetration opening for fluid communication with the building cavity.

4. The device of claim 3, further comprising a filter unit configured to remove particulate matter from the used treatment gas prior to entry into the pressurization unit.

5. The device of claim 4, wherein the filter unit is integrated into the used treatment gas return conduit.

6. The device of claim 1, further comprising an oxygen concentrator configured to receive ambient supply air, concentrate the amount of oxygen in the supply air and supply oxygen enriched supply air to the ozone generator.

7. The device of claim 6, further comprising an induction unit connected to the oxygen concentrator and configured to receive and filter ambient air and feed filtered ambient supply air to the oxygen concentrator.

8. The device of claim 1, wherein the pressurization unit is a high velocity pressurization unit.

9. The device of claim 2, wherein the adaptor is constructed for sealingly connecting the supply conduit to the first penetration opening.

10. The device of claim 3, wherein the outlet adaptor is constructed for sealingly connecting the return conduit to the second penetration opening.

11. A smoke odour abatement method for treating an enclosed smoke affected cavity within a building structure, comprising generating an ozone containing treatment gas, pressurizing the treatment gas and injecting the treatment gas into the cavity to pressurize the cavity with the treatment gas.

12. The method of claim 11, wherein the step of injecting the treatment gas includes identifying a first penetration opening into the cavity and forcing the treatment gas through the first penetration opening into the cavity.

13. The method of claim 12, further comprising identifying a second penetration opening into the cavity which is spaced remote from the first penetration opening, collecting used treatment gas exiting the second penetration opening and reusing the used treatment gas for pressurizing and injecting into the cavity.

14. The method of claim 13, further comprising filtering the used treatment gas prior to reusing.

15. The method of claim 13, including the additional step prior to injecting the treatment gas of identifying and sealing penetration openings into the cavity other than the first and second penetration openings.

16. A portable smoke odour abatement device for removing odour from a smoke-affected cavity accessible through a first penetration opening, comprising:
an induction unit configured to receive and filter ambient supply air,
an oxygen concentrator connected to the induction unit and configured to concentrate the amount of oxygen in the supply air and generate an enriched supply air,
an ozone generator connected to the oxygen concentrator and configured to generate ozone to be mixed with the oxygen enriched supply air to form an ozone containing treatment gas,
a high velocity delivery unit connected to the ozone generator and configured to pressurize the ozone treatment gas,
a manifold splitter configured to receive and disperse the ozone treatment gas from the high velocity delivery unit,
an adjustable damper attached to the manifold splitter and configured to control an outflow of the ozone treatment composition from the manifold splitter,
a treatment gas supply duct attached to the adjustable dampers and configured to supply treatment gas to the cavity, and
an injection adapter configured to link the supply duct to the first penetration opening for fluid communication with the smoke-affected cavity.

17. The portable smoke odour abatement device of claim 16, further comprising a used treatment gas return unit configured to recycle used treatment gas from the smoke affected cavity to the delivery unit, and an outlet port adapter linking the return unit to a second penetration opening into the cavity distal to the first penetration opening for fluid communication with the smoke affected cavity.

18. The portable smoke abatement device of claim 17, the return unit including a filter unit configured to filter the used treatment gas prior to recycling to the delivery unit.

19. The portable smoke abatement device of claim 17, wherein the return unit includes a return duct connected to the outlet port adapter and configured to transport the used treatment gas to the delivery unit, and a filter unit integrated into the return duct and configured to filter the used treatment gas prior to recycling to the delivery unit.

20. The portable smoke odour abatement device of claim 19, wherein the filter unit includes a filter selected from the group consisting of a carbon filter, a HEPA filter and a combination thereof.

21. The portable smoke odour abatement device of claim 16, wherein the induction unit, the oxygen concentrator, the ozone generator, the high velocity delivery unit and the manifold splitter are in serial assembly.

22. The portable smoke odour abatement device of claim 16, wherein the smoke-affected cavity is at least one of the group consisting of a wall, ceiling, sub floor, and duct cavity.

23. The portable smoke odour abatement device of claim 16, wherein the oxygen concentrator produces an oxygen concentration in the enriched supply air of at least about 95%.

24. The portable smoke odour abatement device of claim 16, wherein the wall plate adaptor is constructed for attachment to an electrical outlet or switch.

25. A method of smoke odour abatement for removing odour from a smoke-affected cavity accessible through a first penetration opening, comprising:
collecting ambient air,
concentrating the oxygen in the collected ambient air to generate an oxygen enriched air,
generating ozone and mixing it with the enriched supply air flow to form an oxygen enriched, ozone treatment gas,
compressing the ozone treatment gas, and
injecting the ozone treatment gas, through the first penetration opening into the smoke-affected cavity.

26. The method of claim 25, further comprising:
collecting spent ozone treatment gas from the smoke-affected cavity through a second penetration opening into the cavity located distally to the first penetration opening, and admixing the used treatment gas with the treatment gas prior to the step of compressing the treatment gas.

27. The method of claim 26, further comprising filtering the used treatment gas prior to admixing with the treatment gas.

28. The method of claim 27, wherein the filtering includes removing suspended particlulates from the used treatment gas.

29. The method of claim 28, wherein the smoke-affected cavity is at least one of the group consisting of a wall, ceiling, sub floor and duct cavity.

30. The method of claim 25, wherein in the concentrating, the ambient air is enriched to an oxygen level of at least about 80%.

31. The method of claim 30, wherein the ambient air is enriched to an oxygen level of about 80% to 95%.
